(19) United States
(12) Patent Application Publication
(10) Pub. No.: US 2014/0075100 A1
(43) Pub. Date: Mar. 13, 2014

(54) MEMORY SYSTEM, COMPUTER SYSTEM, AND MEMORY MANAGEMENT METHOD

(71) Applicant: KABUSHIKI KAISHA TOSHIBA, Tokyo (JP)

(72) Inventors: Atsushi KANEKO, Kanagawa (JP); Masahiro TAMURA, Tokyo (JP); Hiroshi NISHIMURA, Tokyo (JP); Yasuo KUDO, Tokyo (JP)

(73) Assignee: KABUSHIKI KAISHA TOSHIBA, Tokyo (JP)

(21) Appl. No.: 13/787,250

(22) Filed: Mar. 6, 2013

(30) Foreign Application Priority Data
Sep. 12, 2012 (JP) P2012-200638

(51) Int. Cl. G06F 12/02

(52) U.S. Cl. CPC G06F 12/0246
USPC 711/103

(57) ABSTRACT

A memory system includes a non-volatile memory having a physical memory region and a controller for conducting data transmission between the non-volatile memory and a host. The controller includes a section management module and a wear leveling module. The section management module divides the physical memory region into multiple sections including a first section and one or more of second sections. The wear leveling module performs independent wear leveling for each of the second sections without performing wear leveling for the first section. The section management module performs expansion of the first section according to a physical memory region expansion request from the host.

### CROSS-REFERENCE TO RELATED APPLICATION

This application is based upon and claims the benefit of priority from Japanese Patent Application No. 2012-200638, filed Sep. 12, 2012; the entire contents of which are incorporated herein by reference.

### FIELD

Embodiments described herein relate to memory systems, computer systems and memory management methods.

### BACKGROUND

The SSD (Solid State Drive) loaded with memory chips equipped with NAND type memory cells has been attractive for computer systems like personal computers (PC), etc. The SSD has the advantages of high speed, light weight, and the like as compared with the magnetic disk apparatus.

### DESCRIPTION OF THE DRAWINGS

FIG. 1 is a diagram showing the configuration of an SSD.

FIG. 2 is a circuit diagram showing an example configuration of one block included in a memory cell array.

FIG. 3 is a diagram illustrating the configuration of memory in a NAND memory, according to embodiments of the invention.

FIG. 4 is a diagram illustrating the configuration of memory in a NAND memory, according to embodiments of the invention.

FIG. 5 is a diagram explaining the configuration of a controller, according to embodiments of the invention.

FIG. 6 is a diagram explaining the operation of an SSD during configuration, according to embodiments of the invention.

FIG. 7 is a diagram explaining the operation of an SSD according to a first embodiment during expansion of the section.

FIG. 8 is a diagram explaining the operation of an SSD according to a second embodiment during expansion of the section.

### DETAILED DESCRIPTION

Embodiments provide a memory system, computer system and memory management method which are capable of effectively reducing the generation of faults such as those preventing starting of the computer system.

In general, according to one embodiment, cells (memory cell transistor, memory cell), which are used in SSDs, have an upper limit in the number of rewrites of data that can be performed on the cell. Therefore, the life of an SSD is shortened if rewriting is concentrated in one place. To prevent this, wear leveling is performed. Wear leveling is a technique of transferring data from a cell having many rewrites to a cell having few rewrites to make the number of rewrites in all cells uniform.

According to one embodiment of the present disclosure, a memory system includes non-volatile storage having a physical memory region and a controller for conducting data transmission between the non-volatile memory and a host. The controller includes a section management module and a wear leveling module. The section management module divides the physical memory region into multiple sections, including a first section and one or more second sections. The wear leveling module performs wear leveling for each section in the second sections and does not perform wear leveling for the first section. The section management module performs expansion of the second sections according to a region expansion request from the host.

If a cell storing system data or other data that affect the effective management of a computer system (e.g., operation system (OS) data), experiences failure, a fatal situation preventing start-up of the computer system generally occurs. Namely, data cannot be read out from the SSD. Wear leveling is performed without distinguishing system data vs. user data (application program vs. data prepared by user). The probability of causing loss of system data is then generally equal to the probability of causing loss of user data. A fatal situation occurs if the system data are lost at startup of the SSD.

The rewrite frequency of system data is generally less than that of user data. According to embodiments of the disclosure, the rewrite frequency of a memory region is made smaller than other memory regions by specifying a memory region for storing system data and omitting wear leveling in this memory region. In this way, the rewrite frequency of the memory region for system data can be made lower than that for other memory regions, so that a failure such as prevention of start-up of the computer system can be reduced in likelihood. According to embodiments of the present disclosure, a host can expand memory regions specified for storing system data by transmitting the prescribed requirement to the SSD.

Hereinafter, the memory system, computer system and memory management method according to the embodiments are explained in detail with reference to the attached drawings. To that end, an explanation is given in the instance of applying the memory system of the embodiments to an SSD, however the applicability of the memory system of the embodiments is not limited to SSDs. Furthermore, the present disclosure is not limited to the disclosed embodiments.

### First Embodiment

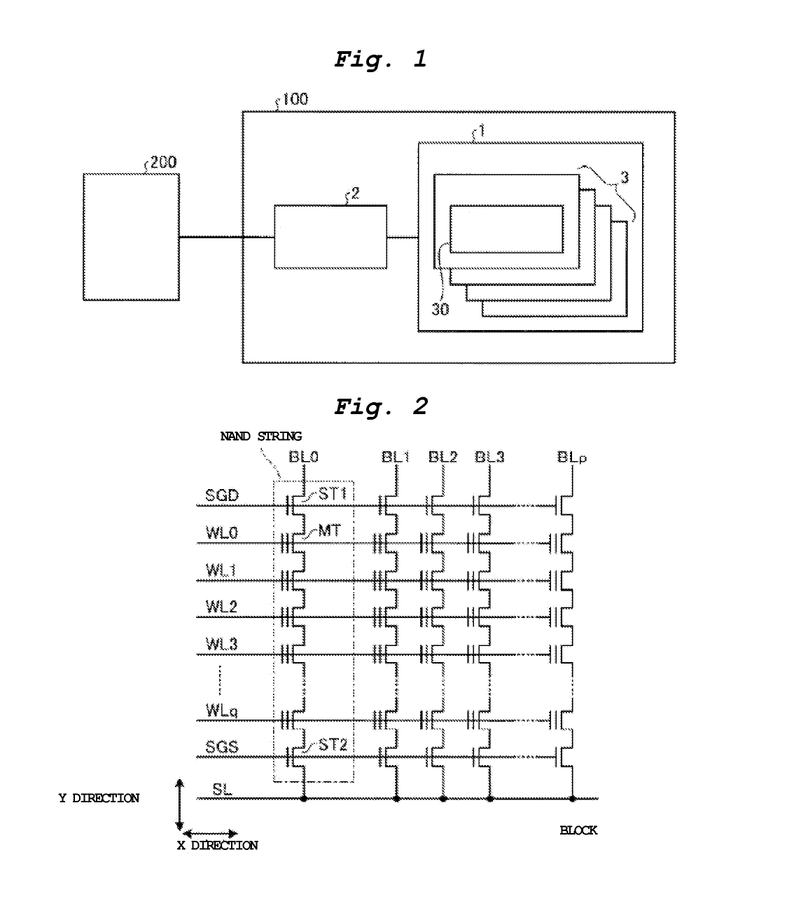

FIG. 1 is a diagram showing the configuration of an SSD. Together with central processing unit (CPU) and host 200, SSD 100 constitutes a computer system of the embodiment. SSD 100 functions as an external memory device of host 200. Reading-out requests or writing-in requests being received from host 200 of SSD 100 include a front address of an accessed object, which is defined in LBA (Logical Block Addressing), and sector size which shows the scope range of accessed objects. Furthermore, communication interface between SSD 100 and host 200 can employ appropriate communication interface standards, such as SATA (Serial Advanced Technology Attachment), SAS (Serial Attached SCSI), PCIe (PCI Express), and the like.

Here, an address described by an LBA is called a logical address.

SSD 100 is provided with NAND memory 1 and controller 2, which performs data transmission between host 200 and NAND memory 1. The NAND memory 1 includes one or more memory chips 3, each of which is provided with a memory cell array 30. Memory cell array 30 includes multiple blocks that function as a single unit.

FIG. 2 is a circuit diagram showing an example construction of one block included in memory cell array 30. As graphically illustrated, each block is provided with (m+1) units of NAND strings arranged along the X direction (where m represents an integer of 0 or higher). Within a selection transistor ST1 to be included in (m+1) units of NAND strings, the drain is connected to bit line BL0-BLp, and the gate is commonly connected to the select gate line SGD. Further, in selection transistor ST2, the source is connected to the source line SL, and the gate is connected to the select gate line SGS.

Each memory cell transistor MT includes a MOSFET (metal oxide semiconductor field effect transistor) having a laminated gate structure formed on a semiconductor substrate. The laminated gate structure includes a charge accumulating layer (floating gate electrode) formed on the semiconductor substrate via a gate insulating film and a control gate electrode formed on the charge accumulating layer via an insulating layer between the gates. Memory cell transistor MT changes threshold voltage value according to the number of electrons stored in the floating gate electrode, and stores data complying with the difference of the threshold value voltage. The memory cell transistor MT may be configured in a mode for storing 1 bit or for storing multiple values (data of 2 or more of bits).

In each NAND string, (n+1) memory cell transistors MT are arranged between the source of selection transistor ST1 and the drain of selection transistor ST2 so as to serially connect the current passage, respectively. The control gate electrode is connected to the word line WL0-WLq successively from memory cell transistor MT positioned at the most-drain side. Thus, the drain of memory cell transistor MT connected to word line WL0 is connected to the source of selection transistor ST1, and the source of memory cell transistor MT connected to word line WLq is connected to the drain of selection transistor ST2.

Word lines WL0-WLq are connected in common to the control electrode of memory cell transistor MT between NAND strings in a block. Then, the control gate electrodes of memory cell transistors MT in the same direction in the block are connected to the same word lines WL. (m+1) units of memory cell transistors MT to be connected to same word lines WL are handled as one page, and data writing in and data reading out are carried out in a pagewise fashion.

Bit lines BL0-BLp are connected in common to the drain of selection transistor ST1 between blocks. Then, NAND strings in the same line in multiple blocks are connected to same bit line BL.

Furthermore, the memory cell array 30 that forms the memory region of NAND memory 1 may be multi-level memory (MLC: Multi Level Cell) storing two bits or more in one memory cell, or single-level memory (SLC: Single Level Cell) storing one bit in one memory cell.

Memory cell array 30 provided in memory chip 3 constitutes the physical memory region of NAND memory 1. According to the first embodiment, the physical memory region provided in NAND memory 1 is managed by controller by division into a memory region assigned to store system data and another memory region.

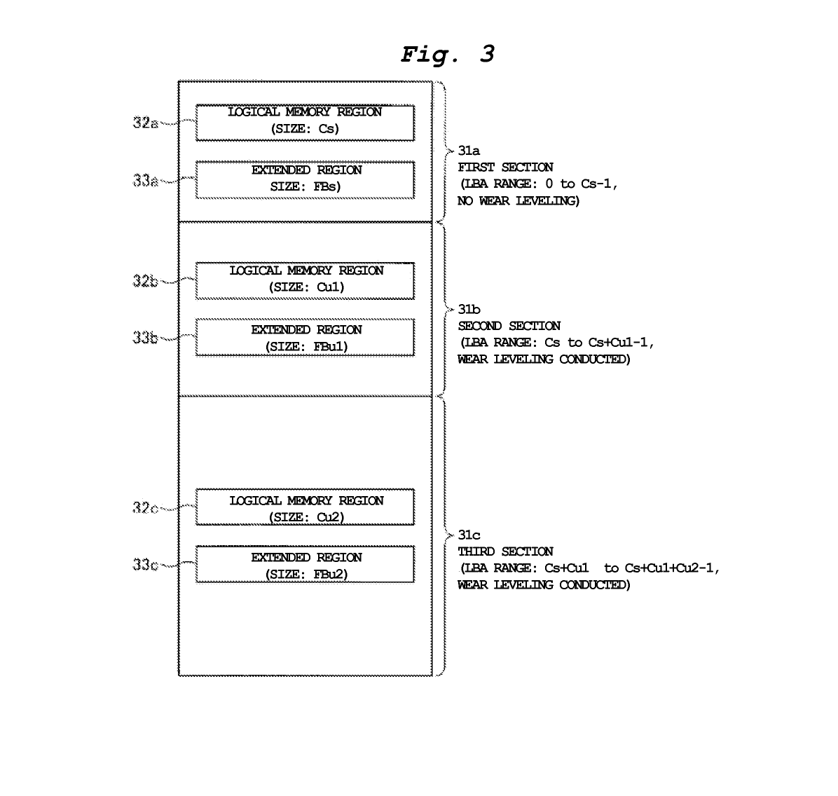

FIG. 3 is a diagram illustrating the configuration of memory in a NAND memory 1, according to embodiments of the invention. The physical memory region of NAND memory 1 is divided into first section 31a, second section 31b, and third section 31c. Wear leveling is not performed in first section 31a but is performed in second and third sections 31b and 31c.

First section 31a is the region wherein host 200 writes in system data. Second section 31b is the region wherein host 200 writes in data having relatively low rewrite frequency among user's data (for example, application program, validation code data for an application program, etc.). Third section 31c is the region wherein host 200 writes in data having relatively high rewrite frequency among user's data (for example, data prepared by user, animation film, imaged, etc.). Division of the memory region of NAND memory 1 can be appropriately established at the time of configuration by host 200. Hereinafter, when first section 31a, second section 31b, and third section 31c are expressed as one general entity, the term “section 31” may be used.

Each region is provided with an LBA-allocated region and an extended region. Namely, the first section 31a is provided with logical memory region 32a and extended region 33a. Likewise, the second section 31b is provided with logical memory region 32b and extended region 33b and the third section 31c is provided with logical memory region 32c and extended region 33c.

Logical memory region 32a has a size of, for example, Cs, and logical addresses with a range of 0−Cs−1 are allocated thereto. Logical memory region 32b has a size of, for example, Cu1, and logical addresses with a range of Cs to Cs+Cu1−1 are allocated thereto. Logical memory region 32c has a size of, for example, Cu2, and logical addresses with a range of Cs+Cu1−Cs+Cu1+Cu2−1 are allocated thereto. Host 200 can access the logical memory region 32a to 32c by using a logical address.

Each of extended regions 33a to 33c include one or more free blocks (blocks not allocated with LBA). Each of extended regions 33a to 33c is used for garbage collection in the same section, recovery of pad block, etc. Garbage collection means the operation of collecting valid data from multiple blocks, copying the collected valid data on other blocks, and eliminating the contents of the old blocks. In the course of garbage collection, for instance, valid data are collected from logical memory region 32a and copied on a free block that is maintained in extended region 33a. The copied block is then rewritten in logical memory region 32a, and original copy block is also included in extended region 33a after eliminating the contents of the copied block. In this way, for a cell belonging to one of the sections of section 31, logical addresses for data is allocated by garbage collection so that allocated logical addresses remain valid. Furthermore, in a cell belonging to one of the sections of section 31, a logical address varies within the range allocated to the cell-belonging section 31 as a result of garbage collection. In other words, over time, various logical block addresses are associated with a particular memory cell.

Furthermore, in cells belonging respectively to second section 31b and third section 31c, a logical address may also fluctuate within the range allocated to respective sections as a result of wear leveling.

Each of extended regions 33a to 33c has a corresponding logical memory region sized to comply with the rewriting frequency (i.e., the write amplitude) of the corresponding logical memory region (i.e., logical memory region 32a, 32b, and 32c), respectively. Here, it is written that extended region 33a has a size of FBs; extended region 33b has a size of FBu1; and extended region 33c has a size of FBu2. Furthermore, the write amplitude of section 31 may be selected as desired prior to manufacturing, or may be determined by a command from host 200.

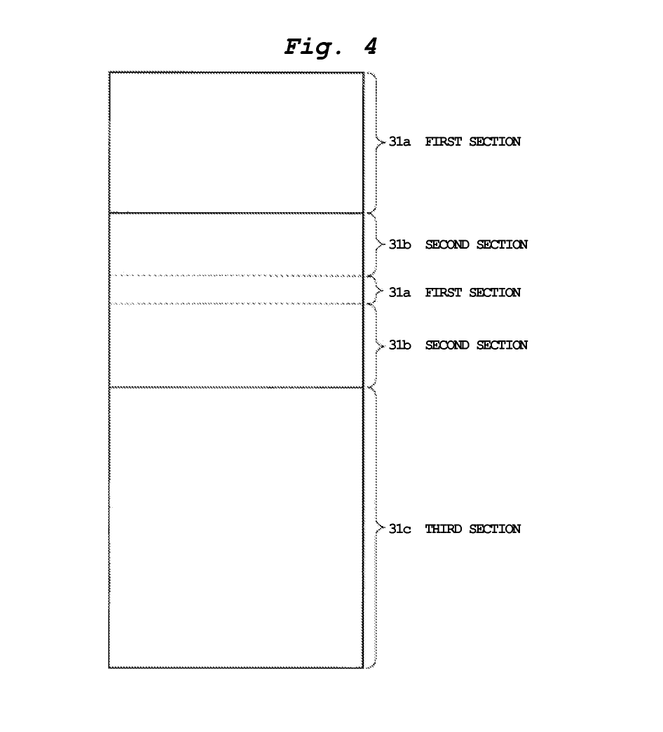

Each of the various sections of section 31 can be expanded by request from host 200. FIG. 4 is a diagram illustrating the configuration of memory in a NAND memory 1 in an instance in which first section 31a is expanded, according to embodiments of the invention. According to this diagram, the region, which is managed as a part of second section 31b in FIG. 3, is included in first section 31a.

Furthermore, hereinafter, the appropriate one of logical memory regions 32a to 32c is sometimes written as logical memory region 32. Further, the appropriate one of extended regions 33a to 33c is sometimes written as extended region 33.

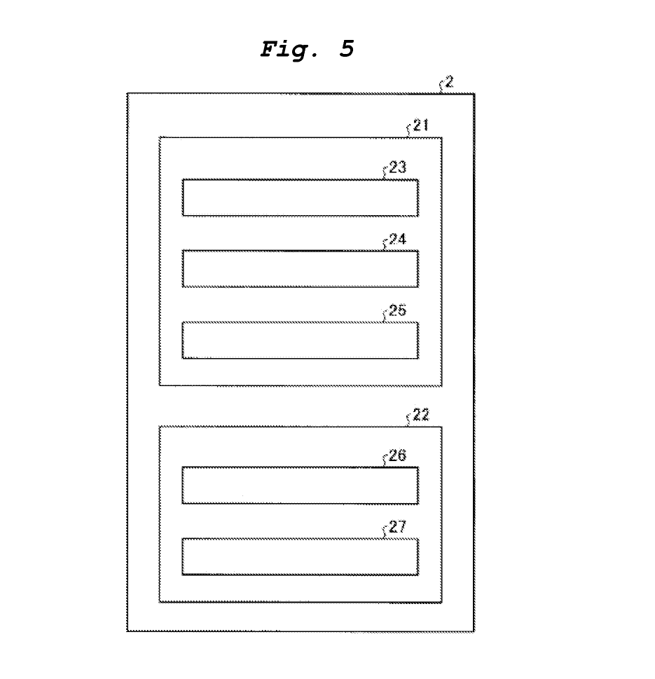

FIG. 5 is a diagram illustrating the configuration of controller 2. Controller 2 is provided with arithmetic unit 21 and memory unit 22. Arithmetic unit 21 is, for example, an MPU (Micro Processing Unit). Memory unit 22 is, for example, ROM (Read Only Memory), RAM (Random Access Memory) or a combination thereof.

Memory unit 22 includes logical-physical conversion table 26, wherein equivalence between a logical address described in LBA and a physical address of NAND memory 1 is recorded and section management information 27, describing the information specifying each section. Here, as an example, it is assumed that the range of addresses (logical address and physical address) for each section is described in section management information 27.

Arithmetic unit 21 functions as read/write module 23, wear leveling module 24, and section management module by executing a prescribed firmware program. The storage location of firmware is not specifically limited. When memory unit 22 includes non-volatile memory, firmware may be housed in memory unit 22 prior to operation. When memory unit 22 includes volatile memory, it may be housed in a prescribed place of NAND memory 1 prior to operation.

Furthermore, some or all of the elements of arithmetic unit 21 may include hardware circuits.

Section management module 25 forms (divides) sections in the physical memory region of NAND memory 1 based upon region preparation requests from host 200. Particularly, section management module 25 divides the physical memory region of NAND memory 1 into multiple sections including a section of no wear leveling (i.e., first section 31a) and one or more sections of wear leveling (i.e., second sections 31b and 31c). A region preparation request includes 1) assignment of the range described in terms of logical address and 2) assignment of degree of priority. Section management module 25 creates a correspondence between the assigned address range and the assigned degree of priority and subsequently registers the correspondence in section management information 27.

Section management module 25 conducts expansion of sections in compliance with region expansion requests from host 200.

The degree of priority is used as information for specifying sections. When host 200 issues a request to expand any of section 31 (region expansion request), for instance, the section subject to expansion is assigned using a degree of priority. Here the section to which the highest degree of priority is assigned is denoted as first section 31a; the section to which next second highest degree of priority is assigned is denoted as second section 31b; and the section to which the third highest degree of priority is assigned is denoted as third section 31c.

Read/write section 23 writes data into NAND memory 1 as requested by host 200. Furthermore, read/write section 23 reads out data from NAND memory 1 and transfers the read-out data to host 200 as requested by host 200. Read/write section 23 can specify the physical address of an accessed object by referring to logical-physical conversion table 26 when data are accessed from NAND memory 1.

Read/write section 23 can execute garbage collection in each section when invalid data increases in logical memory region 32 and extended region 33 belonging to same section is full. Read/write module 23 can recognize the boundary of each section by referring to section management information 27. When a change occurs in the correspondence relation between logical address and physical address due to garbage collection, read/write section 23 records the change to logical-physical conversion table 26.

Wear leveling module 24 separately executes wear leveling of second section 31b and third section 31c. Namely, wear leveling module 24 executes wear leveling to data housed in second section 31b and executes wear leveling to data housed in third section 31c. When wear leveling is executed, the physical address of the data transferred by wear leveling is changed. Wear leveling module 24 reflects the modified correspondence in logical-physical conversion table 26 when the correspondence between logical address and physical address is changed due to the execution of wear leveling. Wear leveling module 24 can recognize the boundary of each section by referring to section management information 27.

Next, the operation of SSD 100 is explained.

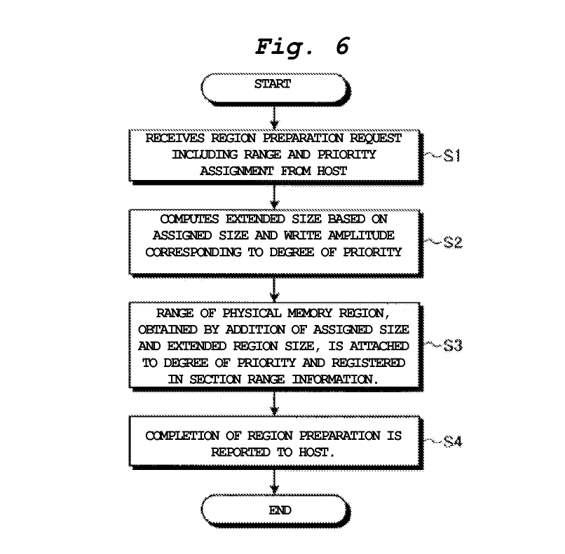

FIG. 6 is a diagram explaining the operation of SSD 100 at configuration. Section management module 25 receives a region preparation request from host 200 in configuration (step S1). A region preparation request includes the assignment of range, described in terms of logical block address (LBA), and the assignment of a degree of priority of the region being prepared. Section management module 25 computes the extended region size, based on the size of assigned range (hereinafter called assignment size) and rewrite frequency (write amplitude), which corresponds to degree of priority (i.e., sections with higher priority have lower write amplitude and vice-versa) (step S2). Furthermore, the relation between degree of priority and write amplitude is predetermined in SSD 100, and section management module 25 specifies write amplitude for the region that corresponds to the assigned degree of priority for the region by referring to this predetermined relation. In step S2, the predetermined write amplitude is used.

Next, section management module 25 attaches the range of physical memory regions obtained by adding assignment size and extended region size to the assigned degree of priority and registers it in section management information 27 (step S3). Furthermore, how the physical memory region obtained by adding assignment size and extended region size is stored or recorded is not specifically limited. Section management module 25 reports the completion of region preparation to host 200 (step S4). The operation of preparing the section is completed.

Host 200 can prepare multiple sections by repeating the operation shown in FIG. 6.

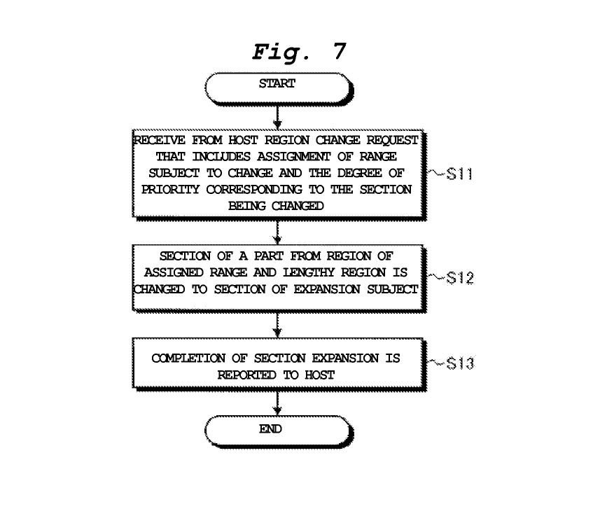

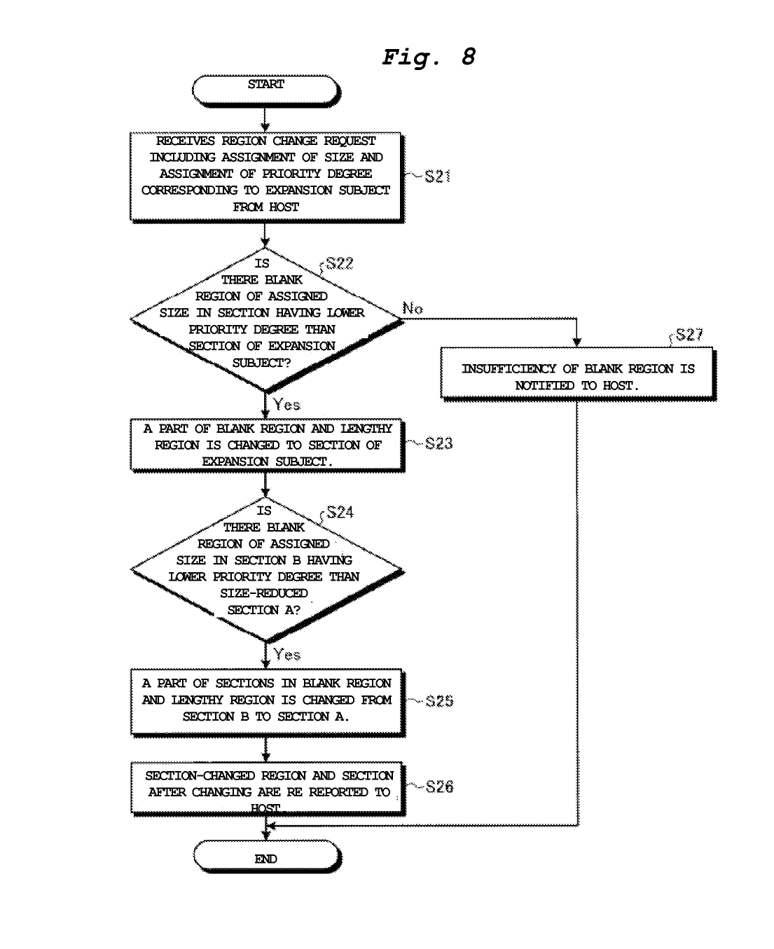

FIG. 7 is a diagram explaining the operation during expansion of a section of SSD 100 according to a first embodiment. First, section management module 25 receives a region change request from host 200 (step S11). According to the first embodiment, the region change request includes the assignment of the range subject to change and assignment of the degree of priority corresponding to the portion of section 31 being changed (i.e., sections 31a, 31b, or 31c).

During a region change requirement, the range subject to change is assigned using a logical address. In other words, the range subject to change is assigned from logical memory region 32 (i.e., one of logical memory regions 32a, 32b, or 32c). In changing a section in the region of the assigned range, a portion of corresponding extended region 33 (i.e., one of extended regions 33a, 33b, or 33c) is also changed to the section corresponding to the degree of priority assigned from the section to which the assigned range belongs. Section management module 25 changes an available portion of extended region belonging to the section being expanded into, the available portion having an appropriate range available, i.e., the same range as the assignment size. Section management module 25 also changes extended region 33 belonging to the section subject to expansion (step S12). Section management module 25 requests the size of the region to be changed in the appropriate extended region 33 based on the same order (i.e., assigned degree of priority) as in step S2. Furthermore, the change of the section is implemented by editing section management information 27.

Then, the section management module 25 reports the completion of section expansion to host 200 (step S13), and the expansion operation of the section is completed.

As described above, according to the first embodiment of the present disclosure, the section management module 25 divides the physical memory region of NAND memory 1 into multiple sections including a section in which wear leveling is not executed, and one or more sections in which wear leveling is executed, and subsequently conducts the expansion of sections by complying with a region expansion request from host 200. Thus, it is possible to provide a section, in which the increase in rate of write frequency is lower than other sections, in host 200. Host 200 places system data in the section in which the rate of write frequency is lower than other sections, and places user data in other sections so that the reliability of system data is higher than user data. Furthermore, host 200 can expand a system data storage section which has become insufficient, by updating system data, etc. since the host can expand sections by issuing region expansion requests. Thus, effective management can be carried out for reducing the occurrence of a failure such as that preventing computer system start-up.

The region expansion request includes the assignment of a degree of priority as section information for specifying the region subject to change and the section to be expanded into, and the section management module 25 changes the section of the region subject to change that is assigned in the section expansion request to the section that is specified by the assigned degree of priority. In this way, host 200 can freely expand a section that has insufficient storage capacity for system data.

### Second Embodiment

According to the first embodiment, it is necessary that a host provides the SSD 100 with an assigned range that is subject to change and perform a region expansion request. According to a second embodiment, a host can send a request for region expansion without assigning the range to the SSD.

The components of a computer system according to the second embodiment are the same as those of the first embodiment except for the section management module. Therefore, the section management module according to the second embodiment is denoted with 28 to, be distinguished from that of the first embodiment, and the components that are the same as those of the first embodiment are given common reference numbers to avoid repeated explanation.

According to the second embodiment, host 200 can issue to SSD 100 the degree of priority that specifies the section to be expanded and the address range that is subject to expansion. When the region expansion request is received, section management module 28 obtains the region having the assignment size from a blank region of a section having a priority at least a degree lower than the assigned priority of the section being expanded, and the obtained region can be added to the section being expanded.

FIG. 8 is a diagram which explains the operation of expansion of a section of SSD 100 according to a second embodiment. First, section management module 28 receives a region change request from host 200 (step S21). According to the second embodiment, region management module 28 includes assignment of size and assignment of degree of priority corresponding to the section subject to expansion.

Then, section management module 28 determines whether a blank region having the necessary assignment size exists in section 31 with a degree of priority lower than the section 31 that is the subject of expansion (i.e., is there a logical memory region 32 of section 31 with a degree of priority lower than section 31 of the section that is being expanded?) (step S22). Here, section management module 28 searches the section 31 having a degree of priority that is lower than the section 31 that is the subject of expansion. The searching is performed in order of descending priority, starting with those sections having the higher degree of priority. If there is a blank region that can accommodate the assignment size in a section with a degree of priority lower than the section subject to expansion (step S22, yes), section management module 28 changes a part of said blank region and associated extended region 33 to the section subject to expansion (step S23).

By treatment of step S23, sections are generated where the size of a blank region that can accommodate the assignment size is reduced as part of the region change request. Section management module 28 then determines whether a blank region of appropriate size exists in a section (called section B) with a degree of priority lower than the section that is reduced in size in step S23 (called section A) (step S24). To that end, in step S24, section management module 28 searches section 31 in descending order of degree of priority. When there is a blank region of appropriate size in section B (step 24, Yes), section management module 28 changes a part of the blank region and extended region from section B (the section with the higher degree of priority) to section A (the section with the lower degree of priority) (step S25). Section management module 28 continues to perform step S24 after completing treatment of step S25 until no blank regions of the appropriate size are available in sections of lower priority.

When there is no blank region that can accommodate the assignment size in section B (step 24, No), after changing the range, section management module 28 reports the section-changed region and section to host 200 (step S26) and completes the operation of section expansion. When there is no blank region of that can accommodate the assignment size in the section with a degree of priority lower than the section subject to expansion (step S22, No), section management module 28 reports the insufficiency of blank region (step S27) to host 200 to complete the operation of section expansion.

According to the second embodiment, priority degree is pre-set by host 200 in each of multiple sections; a region expansion request includes assignment of priority specifying expansion size and section that is to be the subject of expansion; section management module 28 searches for a blank region within sections having lower degrees of priority than the section specified by the assigned degree of priority, and changes the section that includes the appropriately-sized blank region to the section that is the subject of expansion. In this way, host 200 can conduct expansion of a section without assigning the specific section to be used for accommodating the section expansion operation.

When host 200 places system data into first section 31a, user data having relatively low write amplitude into second section 31b, and user data having relatively high write amplitude into third section 31c, the increase in rate of rewrite frequency increases in order of first section 31a, second section 31b and third section 31c. Namely, the reliability of each section decreases in order of first section 31a, second section 31b and third section 31c. Since section management module 28 searches blank regions from sections having high degrees of priority first, as mentioned above, regions having high reliability can be changed to sections that can be the subject expansion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory having a physical memory region; and
a controller configured to conduct data transfer between the non-volatile memory and a host, wherein the controller includes a section management module configured to divide the physical memory region into multiple sections including a first section and one or more second sections, and a wear leveling module configured to execute wear leveling independently for each of the one or more second sections and not execute wear leveling for the first section, the section management module being further configured to conduct expansion of one or more of the multiple sections to comply with a physical memory region expansion request received from the host.

2. The memory system according to claim 1, wherein
the physical memory region expansion request includes section information for specifying a physical memory region subject to expansion and a section subject to being expanded into, and
the section management module is further configured to modify the physical memory region subject to expansion to include a portion of the section subject to being expanded into.

3. The memory system according to claim 2, wherein
one or more of the multiple sections include an extended region that is not allocated with logical addresses, and
the section subject to expansion is assigned a logical address.

4. The memory system according to claim 3, wherein the section management module is further configured to allocate to the physical memory region subject to expansion 1) a portion of the section subject to being expanded into and 2) a portion of the extended region of the section subject to being expanded into.

5. The memory system according to claim 1, wherein
a degree of priority is associated with each of the multiple sections by the host,
the physical memory region expansion request includes priority degree information that specifies expansion size of the one or more of the multiple sections and a physical memory region subject to expansion, and
the section management module is configured to search for a blank region within a section having a lower degree of priority than the physical memory region subject to expansion.

6. The memory system according to claim 5, wherein
the section management module is configured to search for the blank region in the multiple sections in descending order of degree of priority.

7. The memory system according to claim 5, wherein
each of the multiple sections includes a logical memory region that has logical addresses allocated thereto and an extended region that does not have logical addresses allocated thereto, and
the section management module is configured to search for the blank region within the logical memory regions of the multiple sections having a degree of priority lower than the physical memory region subject to expansion.

8. A computer system comprising:
a host;
a non-volatile memory having a physical memory region; and
a controller configured to conduct data transfer between the non-volatile memory and the host, wherein the controller includes a section management module configured to divide the physical memory region into multiple sections including a first section and one or more second sections, and a wear leveling module configured to conduct wear leveling independently for each of the one or more second sections and not execute wear leveling for the first section,
wherein the host is configured to issue a physical memory region expansion request for requesting expansion of one or more of the multiple sections; and the section management module is configured to conduct expansion of one or more of the multiple sections to comply with the physical memory region expansion request issued by the host.

9. The computer system according to claim 8, wherein
the physical memory region expansion request includes section information for specifying a physical memory region subject to expansion and a section subject to being expanded into, and
the section management module is further configured to modify the physical memory region subject to expansion to include a portion of the section subject being expanded into.

10. The computer system according to claim 8, wherein
the one or more of the multiple sections include an extended region that is not allocated with logical addresses, and
the host is configured to assign the section subject to expansion with logical addresses.

11. The computer system according to claim 10, wherein
the section management module is configured to allocate to the physical memory region subject to expansion a portion of the section subject to being expanded into and a portion of the extended region of the section subject to being expanded into.

12. The computer system according to claim 8, wherein
the host is configured to associate a degree of priority with each of the multiple sections,
the physical memory region expansion request includes priority degree information that specifies expansion size of the one or more of the multiple sections and a physical memory region subject to expansion, and
the section management module is configured to search for a blank region within a section having a lower degree of priority degree than the physical memory region subject to expansion.

13. The computer system according to claim 11, wherein
the section management module is configured to search for the blank region in the multiple sections in descending order of degree of priority.

14. The computer system according to claim 13, wherein
each of the multiple sections includes a logical memory region that has logical addresses allocated thereto and an extended region that does not have logical addresses allocated thereto, and
the section management module is configured to search for the blank region within the logical memory regions of the multiple sections having a lower degree of priority than the physical memory region subject to expansion.

15. A management method for execution by a controller which conducts data transfer between non-volatile memory having a physical memory region and a host, the method comprising:
dividing the physical memory region into multiple sections including a first section and one or more second sections;
designating the first section as a non-wear leveling section and conducting wear leveling independently for each of the second sections; and
when a physical memory region expansion request is received from the host, carrying out section expansion complying with the physical memory region expansion request.

16. The management method according to claim 15, wherein
the physical memory region expansion request includes section information for specifying a physical memory region subject to expansion and a section subject to being expanded into, and
the section corresponding to the physical memory region subject to expansion is modified to include the section subject to being expanded into.

17. The management method according to claim 16, wherein
the one or more of the multiple sections includes an extended region that is not allocated with logical addresses, and
the section subject to expansion is assigned with logical address, and
a part of the extended region of the section subject to expansion is modified to include a portion of the section subject to being expanded into.

18. The management method according to claim 15, wherein
a degree of priority is associated with each of the multiple sections by the host,
the physical memory region expansion request includes priority degree information that specifies expansion size of the one or more of the multiple sections and a physical memory region subject to expansion, and
a blank region is searched for within a section having a lower degree of priority than the physical memory subject to expansion.

19. The management method according to claim 18, wherein the blank region is searched for in the multiple sections in descending order of degree of priority.

20. The management method according to claim 18, wherein
each of the multiple sections includes a logical memory region that has logical addresses allocated thereto and an extended region that does not have logical addresses allocated thereto,
the section management module is configured to search for the blank region within the logical memory regions of the multiple sections having a degree of priority that is lower than a degree of priority associated with the physical memory region subject to expansion, and
a portion of the extended region of the section subject to being expanded into is included in the physical memory region subject to expansion.
